(19) United States
(12) Patent Application Publication
(10) Pub. No.: US 2024/0270263 A1
(43) Pub. Date: Aug. 15, 2024

(54) CONTROL DEVICE AND ASSISTANCE SYSTEM FOR A VEHICLE

(71) Applicant: Continental Autonomous Mobility Germany GmbH, Ingolstadt (DE)

(72) Inventors: Ingmar Neumann, Heddesheim (DE); Thorsten Ehrenberg, Bad Nauheim (DE); Adrian Traskov, Steinbach (DE)

(73) Assignee: Continental Autonomous Mobility Germany GmbH, Ingolstadt (DE)

(21) Appl. No.: 18/570,458

(22) PCT Filed: Jun. 15, 2022
(86) PCT No.: PCT/DE2022/200132

§ 371 Date: Dec. 14, 2023

(30) Foreign Application Priority Data
Jun. 22, 2021 (DE) 10 2021 206 379.9

(51) Int. Cl. B60W 50/02; B60W 50/04

(52) U.S. Cl. CPC B60W 50/0205; B60W 50/04

(57) ABSTRACT

A control device for a vehicle, comprising a calculation region and a verification region, wherein the calculation region is set up to calculate trajectories and to output driving commands, and the verification region comprises two verification platforms which are separate from one another. The verification platforms each comprise a driving command and input monitor for monitoring the calculated trajectories as well as a communication device for connecting the verification platforms to one another and to the calculation region.

### CROSS-REFERENCE TO RELATED APPLICATIONS

The present application is a National Stage Application under 35 U.S.C. § 371 of International Patent Application No. PCT/DE2022/200132 filed on Jun. 15, 2022, and claims priority from German Patent Application No. 10 2021 206 379.9 filed on Jun. 22, 2021, in the German Patent and Trademark Office, the disclosures of which are herein incorporated by reference in their entireties.

### BACKGROUND

### 1. Field

Embodiments of the present application relate to a control device, in particular for a vehicle, as well as an assistance system for (partly) autonomous driving for a vehicle.

2. Description of Related Art Modern means of transport such as motor vehicles or motorcycles are increasingly being equipped with driver assistance systems which, with the aid of sensor systems, detect the surroundings, recognize traffic situations and assist the driver, e.g., by a braking or steering intervention or by outputting a visual or acoustic warning. Radar sensors, lidar sensors, camera sensors or the like are regularly deployed as sensor systems for detecting the surroundings. Conclusions can subsequently be drawn about the surroundings from the sensor data determined by the sensors with which, e.g., an object and/or surroundings classification or an environmental model can be generated. Due to current automation trends in the automotive industry, in particular in the field of such assistance systems up to autonomous driving, the complexity of electronic and electrical components as well as the requirements of their availability and functional safety are increasing rapidly. The error-free function of the components specifically and the error-free cooperation of these components are decisive for error-free traffic operation. In particular, the hardware and software architecture is of particular importance when different components and functionalities and sub-functionalities work together.

In the field of (partly) autonomous driving, a route or a trajectory to be driven (driving trajectory) and corresponding driving commands are calculated via the assistance system, which allow the vehicle to follow this driving trajectory. In the case of a system having level 3, level 4 or level 5 automation, it is assumed that the system also provides such a (valid, i.e., checked) driving trajectory and corresponding driving commands if an error occurs in the hardware. In modern assistance systems, the driving trajectory is, as a general rule, calculated by software which runs on a dedicated system-on-chip (SoC). A second SoC calculates a reference trajectory or a reference corridor for the countercheck. If the driving trajectory and the reference trajectory do not match, the control is transferred to a so-called fallback level or a fallback system. As a general rule, the fallback level itself consists, in turn, of two SoCs, one for calculating the driving trajectory and one for calculating the reference trajectory. In the case of such configurations, two separate electronic control units (ECUs) having two high-performance SoCs are therefore required in each control unit. This leads to high material outlay and material costs (e.g., four SoCs, two housings and the like), high production costs (two separate ECUs), high power consumption and, consequently, high power costs. Moreover, a further transfer of control to the fallback level can lead to uncertainties since the transfer can last, for example, up to multiple 100 ms.

A method for the control of a safety-relevant process is known from DE 10 2018 209 833 A1, wherein at least two microcontrollers are deployed for at least two control branches for the control, wherein each of the at least two microcontrollers is embodied for controlling the safety-relevant process. The microcontrollers process the data from at least one sensor which detects the actual behavior of the respective control branch. Furthermore, the data from the respective sensor or data derived therefrom are exchanged between the two microcontrollers, wherein one decision-making module is provided for each microcontroller, which verifies whether the data from the sensors are consistent.

Furthermore, methods are also known from US 2013 007513 A1 and US 2013 024721 A1, which deal with increasing availability, wherein measures are described with which a defective partial circuit is recognized in order to increase the diagnostic capability.

A problem now consists of making available a generic control device as well as a corresponding assistance system for (partly) autonomous driving, with which the disadvantages from the prior art are overcome, wherein the material outlay and the power consumption are reduced in a simple and inexpensive manner.

SUMMARY According to an aspect of an embodiment, there is provided a control device used for a vehicle and comprises a calculation region and a verification region, wherein the calculation region is set up to calculate trajectories and to output driving commands. The verification region comprises two verification platforms which are separate from one another, wherein the verification platforms each comprise a driving command and input monitor for monitoring the calculated trajectories and a communication device for connecting the verification platforms to one another and to the calculation region.

This results in the advantage that only one central control device is required instead of two or more control devices. This results in increased availability (due to the reduced number of components) and, consequently, increased reliability (due to the reduced number of components) as well as greater diagnostic coverage. Furthermore, fewer control units are required per function, as a result of which the energy consumption and the control unit costs are especially reduced.

The central control device can be realized by a single SoC or, alternatively, a multi-chip module, comprising multiple individual ICs (chiplets).

According to an aspect of an embodiment, a main platform and a fallback platform are provided as verification platforms. As a result, a seamless transfer from normal operating mode to emergency mode will be made possible without delay in the event of a failure of the calculation platform. This results in the advantage that a quick switchover of the control in the event of an error is even further promoted or made possible.

The verification platforms or main platform and fallback platform are preferably logically and/or functionally identical.

The verification platforms or main platform and fallback platform expediently execute the monitoring in parallel.

Furthermore, the verification platform can have at least one security unit for recognizing errors, wherein a verification platform is brought into a fail-silent state by the security unit as soon as the security unit recognizes an error in this verification platform.

The security unit of the main platform preferably sends information about its internal status to the fallback platform and vice versa.

The driving command and input monitor expediently comprises a security unit which receives error messages from the verification platform and places the corresponding verification platform in a fail-silent state as soon as an error has been notified to the security unit.

Furthermore, the driving command and input monitor can have a central computing unit which can be implemented in the hardware lockstep.

According to an aspect of an embodiment, the calculation region comprises multiple, in particular three, independent computer platforms. As a result, only three (high-performance) computer platforms are required, in contrast to the previous prior art according to which, as a general rule, more than four high-performance computer platforms are provided. The utilization of many and varied software programs on the three computer platforms is made possible, wherein the utilization of various software can facilitate ASIL decomposition. As a result, the utilization of many and varied types of hardware in the three computer platforms is, in addition, made possible (in particular, the utilization of different hardware components of ASIL decomposition is made possible and the performance is optimally adapted to the requirements of the corresponding software). This especially improves and/or simplifies the software development process.

A computer platform preferably comprises a processing unit for data processing, a memory, in particular for storing programs and/or data of the processing unit, as well as a communication device, in particular for communicating, or transmitting data of, units of the calculation region and/or units of the verification region.

Each computer platform can expediently run the calculation of the trajectories and the respective driving command independently of the other computer platforms.

Furthermore, each computer platform of the calculation region can be supplied via a separate supply voltage.

As a result of the fact that the supply voltages are provided by at least two independent supply networks, an additional safeguard is created since, in the event of a failure of one supply network, a supply voltage can still be provided via the other supply network. This configuration represents a particularly advantageous variant, in particular with respect to the “single chip” or “chiplet-based multi-chip module (MCM) integration”, since in known systems care must always be taken that the signals from the different supply networks or “power domains”, which are not supplied in the event of an error, do not lead to additional unexpected errors.

Each computer platform of the calculation region preferably has a separate clock generation system. As a result, the probability of a failure of the entire system due to the failure of one clock generation system is avoided.

According to an aspect of an embodiment, the communication between and within the calculation region and the verification region can be protected or coded by means of EC codes and/or end-to-end ECC/EDC codes.

Furthermore, the communication device can be configured as a “network-on-chip” (NoC). A “network-on-chip” is a network-based communication subsystem on an integrated circuit (IC) or IC component which, as a general rule, is deployed between modules in a “system-on-a-chip” (SoC). The term “network-on-chip” (NoC) refers to the needs-based adaptation of the network between the calculation units which are qualitatively designed, in a needs-based manner, in relation to latency, bandwidth, safety and security requirements. Therefore, “network-on-chip” (NoC) is not understood to mean the networking of modules with known bus systems (such as, e.g., CAN, Flexray, Ethernet) striven for, e.g., in the case of previous solutions with distributed control units.

The verification of the calculated trajectory and of the respective driving command can be expediently carried out by a comparison test, in particular a 2003 comparison. The comparison process makes possible a deviation or tolerance in value and time between the data which are received from the three computer platforms. Alternatively, any other comparison method known from the prior art can, of course, also be deployed, e.g., including 2004 or the like. A triple function and a comparison of the results can be brought about by replicated comparison units.

### BRIEF DESCRIPTION OF THE DRAWINGS

Aspects of the present application are explained in greater detail below with reference to expedient exemplary embodiments, in which:

FIG. 1 shows a simplified schematic representation of a configuration of a vehicle having a control device according to the application;

FIG. 2 shows a simplified schematic representation of a configuration of a driving safety concept of an autonomous L3/L4 system according to the prior art;

FIG. 3 shows a simplified schematic representation of a configuration of a control device according to the application, comprising a calculation region and a verification region;

FIG. 4 shows a simplified schematic representation of a configuration of a driving command and input monitor of a control device according to the application;

FIG. 5 shows a simplified schematic representation of a configuration of the supply principle of a control device according to the application; and

FIG. 6 shows a simplified schematic representation of a configuration of the clock generation principle of a control device according to the application.

### DETAILED DESCRIPTION

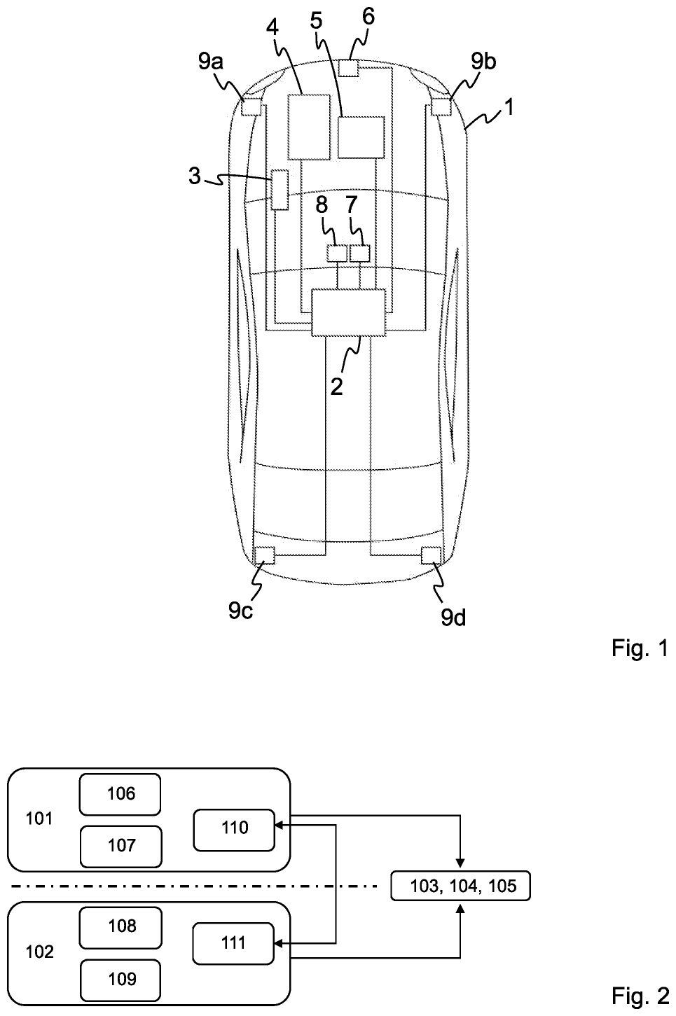

Reference numeral 1 in FIG. 1 designates a vehicle having different actuators (steering 3, engine 4, brake 5), which has a control device 2 according to the application (ECU, electronic control unit or ADCU, assisted and automated driving control unit), by which a (partly) automated control of the ego-vehicle 1 can take place, e.g., in that the control device 2 can access the actuators of the ego-vehicle 1. In addition, the control device 2 has a memory unit in order to store, e.g., an algorithm, control instructions or patterns. Furthermore, the ego-vehicle 1 has sensors for recognizing the surroundings: a radar sensor 6, a lidar sensor 7 and a front camera 8 as well as multiple ultrasonic sensors 9a-9d, the sensor data of which are utilized for recognizing the environment and objects so that different assistance functions such as, e.g., Electronic Brake Assist (EBA), Adaptive Cruise Control (ACC), a Lane Departure Warning System or a Lane Keep Assist (LKA), Park Assist or the like, can be realized. The assistance functions are executed via the control device 2 or the algorithm saved therein.

In FIG. 2, a configuration of the basic principle of a driving safety concept of an autonomous L3/L4 system according to the prior art is depicted. The concept provides a main path 101 and a fallback level 102, wherein the trajectory to be driven is calculated via the main path 101 (trajectory calculation 106). The main path 101 and fallback level 102 are configured as two separate control devices which, in total, comprise four high-performance SoCs. Furthermore, the main path 101 comprises a monitor 107 which verifies the course of the calculated trajectory and whether this is likely to be converted into an idle state if an internal error occurs. A decision-making module 110 exchanges status information and monitoring data with a decision-making module 111 of the fallback level 102. The fallback level 102 assumes control of the vehicle if the main path 101 fails, so that route control, steering control, braking system control and drive train control can take place via a redundant communication channel (e.g., via a CAN connection), wherein, to this end, the fallback level 102 likewise comprises a trajectory calculation 108 and a monitor 107. The actuators (steering 103, engine 104, brake 105) consequently obtain commands from both paths. The configuration with two separate control devices and four high-performance SoCs results in negative repercussions in terms of energy consumption and expenditure.

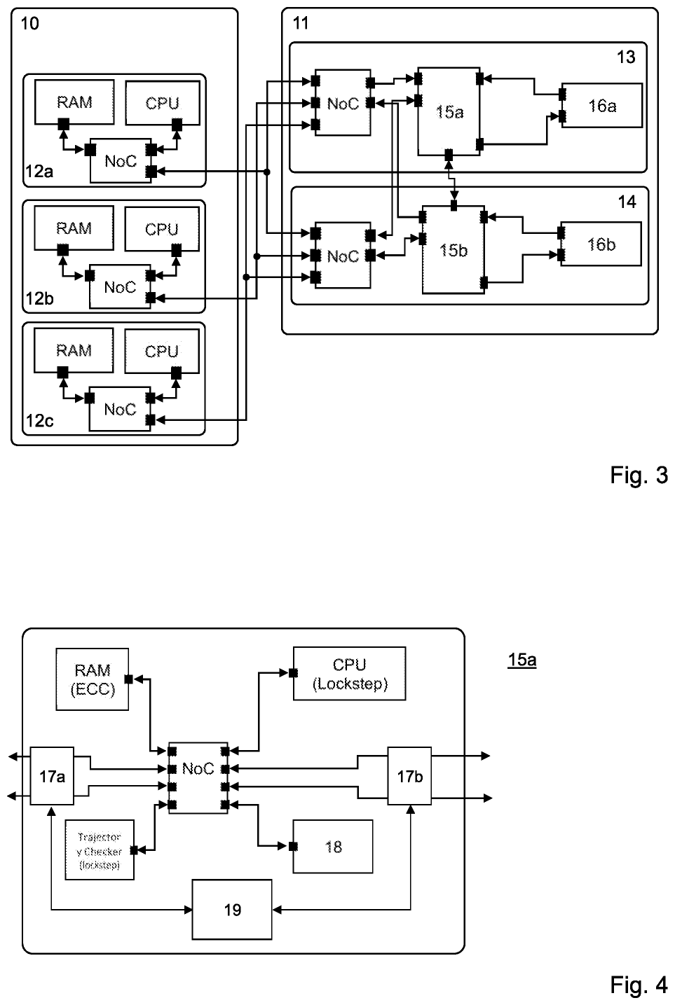

In FIG. 3, a configuration of a control device 2 according to an embodiment is depicted, which comprises a calculation region 10 (compute domain or high-performance computing zone with triplication SW lockstep) and a verification region 11 (check/input/output domain). The calculation region 10 calculates the lanes or trajectories and outputs the corresponding driving recommendations or driving commands. The verification region 11 verifies the integrity of the input data received from the external control units and sensors of the vehicle and makes the checked input data available to the calculation region 10. The realization can be effected by a SoC (single chip) or a MCM (multi-chip module) having multiple chips or chiplets. As a general rule, an MCM comprises multiple individual (micro)chips (or “dies”), which are accommodated next to one another (i.e., in a planar manner) in a common housing.

The verification region 11 makes available both the simply received input data and the input data redundantly received via both communication controllers 16a and 16b, as they occur in zone-based vehicle architectures having redundant networks, to the calculation region 10.

Moreover, the verification region 11 checks the output data calculated by the calculation region 10. Safety-relevant ancillary information (e.g., checksums, time stamp, message number) is additionally calculated for output data which can be sent to external control units and actuator control units (e.g., control units for steering, engine or brake) of the vehicle.

The calculation region 10 consists of three independent computer platforms 12a-12c. Each computer platform 12a-12c preferably comprises processing units (e.g., CPU (central processing unit), GPU (graphics processing unit), dedicated co-processors as AI (artificial intelligence) accelerators, DSP (digital signal processor), memories (e.g., RAM (random-access memory) or SRAM (static random-access memory) or DRAM (dynamic random-access memory) for storing the computer programs to be run by the processing units and data which are processed by the computer programs, peripheral modules which are required for running the programs (timer, interrupt controller, DMA controller) as well as a communication device (e.g., interconnect system) for producing the communication between the indicated components. For example, as shown in FIG. 3, the communication device can be configured as a so-called “network-on-chip” (NoC). Each computer platform runs software for planning trajectories and calculating the respective driving command independently of the (two) other computer platforms. The project archives and the commands are then sent to the verification region 11. The content of the messages can be protected, e.g., by EC codes (ECC: error correction code). Furthermore, the communication via the connection lines can be protected by end-to-end ECC/EDC codes. Moreover, the response to an ECC/EDC error can be programmed.

The verification region 11 comprises two verification platforms which are separate from one another, a main platform 13 and a fallback platform 14 which are preferably logically and/or functionally identical. Each verification platform comprises a driving command and input monitor 15a, 15b and a communication controller 16a, 16b (e.g., Ethernet, FlexRay, CAN or the like) as well as, likewise, a communication device (e.g., NoC, as depicted in FIG. 3) in order to connect the components to one another and to the calculation region 10.

Each driving command and input monitor 15a, 15b comprises hardware and software for verifying the integrity of the input data received from sensors (e.g., checksums, time stamp, message ID or the like) and providing verified data for calculating the domain in a buffer memory, for comparing the roadway with the driving command and for adding safety-relevant ancillary information (e.g., checksums, time stamp, message number or the like) for data which can be transmitted to an external control unit or ECU.

The trajectory and the driving command can be verified, e.g., by “2003” (two out of three) comparative majority voting. The comparison process makes possible a deviation or tolerance in value and time between the data which are received from the three computer platforms.

The driving command and input monitor 15a, 15b additionally contains hardware and/or software for permanent self-monitoring for correct operation, as depicted in FIG. 4 by means of the driving command and input monitor 15a. The central computing unit (e.g., CPU, processor, microcontrollers or the like) is implemented in the hardware lockstep and correct operation is monitored by comparison units. The term lockstep describes the method for tolerating errors and recognizing errors in the hardware, which is achieved by deploying multiple identical or similar units such as CPU cores in multi-core processors. The memory units (RAM) can be protected, e.g., by ECC codes which are calculated and/or verified by ECC/EDC checking units 17a, 17b. The interconnect communication is, in addition, protected by end-to-end ECC/EDC codes which are calculated and/or verified by a special ECC/EDC checking unit or a security module 18. If one of the aforementioned (hardware) security mechanisms recognizes a malfunction, the ECC/EDC checking unit 17a, 17b signals the malfunction to a security unit 19. The security unit 19 then brings the corresponding verification platform into a so-called fail-silent state, that means into a state in which the function is not performed. Accordingly, this system represents a fail-silent system, wherein it is a type of system which either provides the correct service or error-free function or no service or function at all.

Furthermore, the security unit 19 of the main platform 13 sends, in particular at intervals which can be fixed, information about its internal status to the fallback level or the fallback platform 14 and vice versa. In the “normal”, i.e., error-free, operating mode, all of the indicated actions are executed in parallel by the main platform 13 and by the fallback platform 14. Optionally, the sending of data to external control units can be disabled in the normal operating mode for the fallback platform 14, if this is necessary. If a security unit 19 of a verification platform (i.e., of the main platform 13 or the fallback platform 14) recognizes an error, it brings the corresponding verification platform into a fail-silent state and signals this to the security unit 16 of the other verification platform via a constantly evaluated signal. For example, if the security unit 19 of the main platform 13 recognizes an error, it brings the corresponding main platform 13 into a fail-silent state and signals this to the security unit 19 of the fallback platform 14 via a constantly evaluated signal.

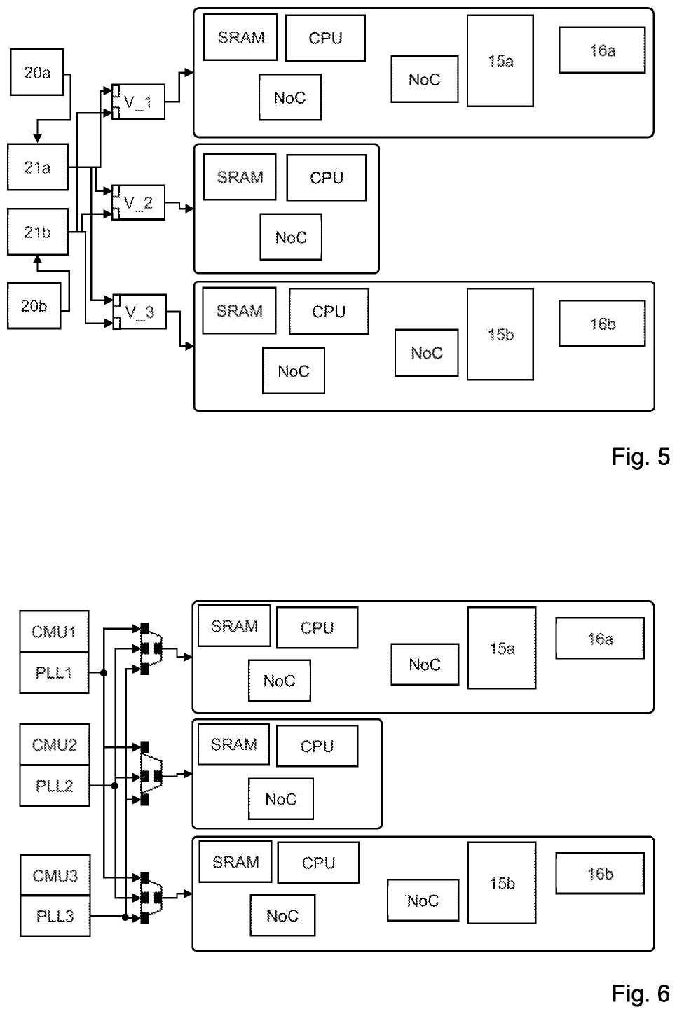

In order to avoid the risk of a loss of function due to a power failure, each of the three computer platforms of the calculation area 10 can be supplied via separate supply voltages, as shown in FIG. 5. The three supply voltages V1-V3 resulting from the separate supply voltages originate from two independent supply networks 20a, 20b in the vehicle, which can have overvoltage protection 21a, 21b. According to the prior art, two independent supply networks are solely deployed in current vehicles which offer autonomous driving. The two verification platforms of the verification region 11 are likewise operated via two separate supply voltages. In the event of an undervoltage, the supplied region or the supplied domain can be reset. In the event of one of the three voltage supplies failing, it can additionally be ensured using known circuit technology that signals which leave one of the three computing platforms of the calculation region 10 are switched to a previously defined signal level for this error scenario using the error signal for the voltage supply. Equally, each of the three computer platforms 12a-12c of the calculation region 10 is monitored by its own clock generation system in order to avoid the risk of a loss of function due to a system failure of a single clock generation system. As shown in FIG. 6, the clock generation system can include a CMU (clock multiplier unit) with PLL (phase-locked loops). The two verification platforms of the verification region 11 are likewise monitored by two different clock generation systems.

In summary, a system which is able to recognize the occurrence of an error within the system and, nevertheless, can continue normal operation (unless a second independent error occurs) is made available by the present application. In addition to the field of driver assistance systems, the present application can consequently be expressly deployed in all fields in which a reliable system is required for safety-critical purposes, e.g., in aviation, shipping, chemical production processes, power plants and the like. Moreover, the present application can be applied in all fields in which a fail-safe system can be advantageous for commercial/available purposes (industrial automation, building automation, and the like).

Furthermore, embodiments of the present application makes possible to switch over the control without delay in the event of an error—which represents a particular problem in the field of automated driving. To this end, the switchover between the currently utilized signal chain (e.g., of the main platform) and a redundant secondary path (e.g., fallback platform) must, as a general rule, occur within a few milliseconds—otherwise, the vehicle would be “driverless” for too long a period of time. However, a (virtually) delay-free switchover cannot easily be achieved in the conventional manner. Furthermore, to safeguard the entire system, the defective path is determined, wherein it is not sufficient to reinitialize (execute a “reset”), since the system will probably find itself in the erroneous path again even after the reset. Consequently, a deterministic and minimal switchover time would not be provided in the event of an error. A reset of the control unit would, in any case, require a reinitialization of the system, which can take multiple seconds to minutes. It has been advantageously shown that a switching over within the required time can be made possible by the application described. A further advantage is that the redundant path preferably has the same architecture as the primary path. In special error scenarios, recourse can also be had to the fail-silent state, wherein it is considered that many and varied possible ways result from the architecture described (in particular due to the configuration as an entire system on a SoC or MCM) of increasing the diagnostic possibility in order to establish the error or the erroneous circuit part—and, therefore, also the availability of the system. On the other hand, this cannot, as a general rule, be realized by way of separate ECU systems.

The deployed chip can be clocked, e.g., in the region of >500 MHZ. An error-free synchronization can be made possible by the simple duplication of the logic (in the synchronized or delayed lockstep). An advantageous combination of the utilization of the two error mechanisms Lockstep for Logic and CPU as well as error recognition or ECC (error correction code) for the memory and regular structures is therefore not easily possible. It has been advantageously shown that the combination of the two known mechanisms can especially reduce the expenditure and energy outlay. The simple application of the duplication cannot identify the defective path and supply a reliable statement that a defect was/is present. Consequently, the illustrated solution describes a novel realization in order to achieve the required switching-over time and diagnostic possibility and, consequently, represents a particular contribution, in particular in the area of control devices.

1. A control device for a vehicle, the control device comprising:
a calculation region; and
a verification region,
wherein the calculation region is configured to calculate trajectories and to output driving commands, and
wherein the verification region comprises two verification platforms which are separate from one another, and
wherein the verification platforms each comprise a driving command and input monitor for monitoring the calculated trajectories and a communication device for connecting the verification platforms to one another and to the calculation region.

2. The control device according to claim 1, wherein the verification platforms comprise a main platform and a fallback platform.

3. The control device according to claim 2, wherein the verification platforms are logically and/or functionally identical.

4. The control device according to claim 3, wherein the verification platforms execute the monitoring in parallel.

5. The control device according to claim 4, wherein the verification platform has at least one security unit for recognizing errors, and
wherein a verification platform is brought into a fail-silent state by the security unit as soon as the security unit recognizes an error in this verification platform.

6. The control device according to claim 5, wherein the security unit of the main platform sends information about its internal status to the fallback platform and vice versa.

7. The control device according to claim 6, wherein the driving command and input monitor comprises a security unit which receives error messages from the verification platform and places the corresponding verification platform in a fail-silent state as soon as an error has been notified to the security unit.

8. The control device according to claim 7, wherein the driving command and input monitor has a central computing unit which is implemented in the hardware lockstep.

9. The control device according to claim 8, wherein the calculation region comprises multiple independent computer platforms.

10. The control device according to claim 9, wherein the computer platform has a processing unit for data processing, a memory, for storing programs and/or data of the processing unit, as well as a communication device, for communicating units of the calculation region and/or units of the verification region.

11. The control device according to claim 10, wherein each computer platform runs the calculation of the trajectories and the respective driving command independently of the other computer platforms.

12. The control device according to claim 11, wherein each computer platform of the calculation region is supplied via a separate supply voltage.

13. The control device according to claim 12, wherein the supply voltages are provided by at least two independent supply networks.

14. The control device according to claim 13, wherein each computer platform of the calculation region has a separate clock generation system.

15. The control device according to claim 14, wherein the communication between and within the calculation region and the verification region is protected by means of EC codes and/or end-to-end ECC/EDC codes.

16. The control device according to claim 15, wherein the communication device is configured as a network-on-chip.

17. The control device according to claim 15, wherein the verification of the calculated trajectory and of the respective driving command is carried out by a comparison test.

18. (canceled)
